(19) United States
(12) Patent Application Publication
(10) Pub. No.: US 2025/0116987 A1
(43) Pub. Date: Apr. 10, 2025

(54) CONTROL DEVICE, INTERFERENCE CHECK DEVICE, AND CONTROL SYSTEM

(71) Applicant: FANUC CORPORATION, Yamanashi (JP)

(72) Inventor: Nobuhito OONISHI, Yamanashi (JP)

(21) Appl. No.: 18/567,360

(22) PCT Filed: Jun. 16, 2021
(86) PCT No.: PCT/JP2021/022930

§ 371 Date: Dec. 6, 2023

(51) Int. Cl. G05B 19/4061

(52) U.S. Cl. CPC G05B 19/4061; G05B 2219/35316

(57) ABSTRACT

A control device according to the present disclosure comprises: a command analysis unit that analyzes the block of a processing program; a distribution processing unit that generates a distributed movement for each distribution period on the basis of the analysis result of the command analysis unit and calculates the position of a motion part, the position being updated according to the distributed movement; and an interference determination unit that determines the presence or absence of an interference between the motion part and an interfering object on the basis of a prohibited motion amount that is calculated by an interference check device on the basis of the position and is a distance for which a movement from the position of the motion part may cause an interference. If it is determined that an interference may occur, the movement of the motion part is stopped.

### RELATED APPLICATIONS

The present application is a National Phase of International Application No. PCT/JP2021/022930 filed Jun. 16, 2021.

### TECHNICAL FIELD

The present invention relates to a control device, an interference check device, and a control system.

### BACKGROUND ART

In industrial machines such as a machine tool controlled by a control device, when a motion part moves along a predetermined motion axis, the motion part may interfere with an obstacle located within a motion range. FIG. 10 is a diagram illustrating a spindle 301 to which a tool 303 is attached as a motion part and a table 305, a workpiece 309, and a jig 307 that fixes a workpiece 309 as obstacles. When the spindle 301 and the tool 303 continue to move in a direction of the arrow in FIG. 10, the spindle 301 finally interferes with the jig 307. When interference occurs, this will cause breakage of the motion part or the obstacle or a failure of a shaft or a motor of the machine. Thus, some control devices have an interference check function of checking in advance a likelihood of interference occurring between a motion part and an obstacle and stopping the motion of the motion part if interference is expected to occur.

The interference check function includes a technology of performing interference check on a control device side and a technology of performing interference check on a PC side connected to the control device. The control device spends most of its computational resources on controlling an industrial machine. Thus, when interference check is performed on the control device side, only simple processing can be performed in many cases. Thus, when it is not possible to perform interference check with computational resources on the control device side such as when an obstacle has complex shape definition, a function of performing interference check used on the PC side connected to the control device (for example, Patent Literature 1 and others).

FIG. 11 is a sequence chart illustrating a flow of processing when a control device and a PC cooperate to perform interference check. When the control device and the PC cooperate with each other to perform interference check, the control device calculates a coordinate value of a position at which the interference check will take place and transmits the calculated coordinate value to the PC at time t_{A}. The PC that received the coordinate value at time t_{B} uses models of a motion part and an obstacle stored in advance (for example, three-dimensional models) to check whether or not interference is expected to occur when the motion part is moved to the position of the transmitted coordinate value. Then, a result of the interference check is transmitted to the control device at time t_{C}. The control device that received the result of the interference check at time t_{D} determines whether or not to stop the motion of the motion part based on the result of the interference check. When it is necessary to stop the motion part, a process to stop the motion part is started at time t_{E}. Then, the motion part is stopped at time t_{F}.

In general, when stopping a motion part based on a result of interference check, the period (t_{C}-t_{B}) taken for an interference check process, the period (t_{E}-t_{D}) taken for determination of interference, and the period (t_{F}-t_{E}) taken for stopping of the motion part and, in addition, a predetermined margin have to be taken into consideration to perform interference check in advance on a forward coordinate value to which the motion part will move in the future. In addition, in the control device and the PC cooperating with each other to perform interference check, it is necessary to take the communication periods (t_{B}-t_{A}) and (t_{E}-t_{D}) taking place between the control device and the PC into consideration. Thus, on the control device side, a forward position (predicted which a position), is destination to which the motion part will move after these periods pass, is calculated as a coordinate value to be subjected to the interference check, and the interference check at this forward position is performed on the PC side.

### CITATION LIST

### Patent Literature

Patent Literature 1: Japanese Patent Application Laid-Open No. 2008-027376

### SUMMARY OF INVENTION

### Technical Problem

In a case of PC-cooperative type interference check using a forward position, the control device has to manage two types of data on a current position and a forward position. This causes a problem of a complex process of managing data. Further, in a machining program that branches in accordance with a situation of machining or the situation of peripheral devices, a predicted candidate of a forward position may be divided into two or more in accordance with the situation. In such a case, if the prediction of a forward position is wrong, there is a problem of inability of correctly performing interference check. Furthermore, some cases need to perform PC-cooperative type interference check even when it is not possible to predict a forward position such as when manual operation is applied.

Accordingly, in PC-cooperative type interference check, there is a demand for a technology that enables interference check to take place without requiring transmission of a forward position to a PC.

### Solution to Problem

The control device according to the present disclosure solves the above problems by newly introducing a concept of a prohibited motion amount and determining interference on the control device side based on the prohibited motion amount calculated on an interference check device.

Accordingly, one aspect of the present disclosure is a control device that controls motion of a motion part of an industrial machine along an axis based on a machining program, wherein the control device performs interference check in cooperation with an interference check device that checks interference between the motion part and an obstacle, the control device include: a command analysis unit that analyzes a block of the machining program; a distribution processing unit that creates a distributed motion amount for each distribution cycle based on an analysis result from the command analysis unit, calculates a position of the motion part updated by the distributed motion amount, and notifies the interference check device of the calculated position; and an interference determination unit that determines whether or not interference between the motion part and the obstacle is expected based on a prohibited motion amount calculated by the interference check device based on the notified position, the prohibited motion amount being such a distance that is likely to cause interference when the motion part moves by the distance from the position of the motion part, and when it is determined by the interference determination unit that interference between the motion part and the obstacle is expected to occur, motion of the motion part is stopped.

Another aspect of the present disclosure is an interference check device that checks interference between a motion part moving along an axis of an industrial machine and an obstacle, the interference check device includes: a model data storage unit that stores models of the motion part and the obstacle; and a prohibited motion amount calculation unit that, based on a position of the motion part notified from a control device that controls the industrial machine and on the models of the motion part and the obstacle stored in the model data storage unit, calculates a prohibited motion amount that is likely to cause interference when the motion part moves by the prohibited motion amount from the position of the motion part, and the calculated prohibited motion amount is transmitted to the control device.

Another aspect of the present disclosure is a control system in which a control device and an interference check device cooperate to perform interference check, the control device controls motion of a motion part of an industrial machine along an axis based on a machining program, and the interference check device checks interference between the motion part and an obstacle. In the control system, the interference check device includes a model data storage unit that stores models of the motion part and the obstacle, and a prohibited motion amount calculation unit that, based on a position of the motion part notified from the control device and on the models of the motion part and the obstacle stored in the model data storage unit, calculates a prohibited motion amount that is likely to cause interference when the motion part moves by the prohibited motion amount from the position of the motion part, the control device includes a command analysis unit that analyzes a block of the machining program, a distribution processing unit that creates a distributed motion amount for each distribution cycle based on an analysis result from the command analysis unit, calculates a position of the motion part updated by the distributed motion amount, and notifies the interference check device of the calculated position, and an interference determination unit that determines whether or not interference between the motion part and the obstacle is expected based on a prohibited motion amount calculated by the prohibited motion amount calculation unit, and when it is determined by the interference determination unit that interference between the motion part and the obstacle is expected to occur, motion of the motion part is stopped.

### Advantageous Effects of Invention

One aspect of the present disclosure enables interference check in cooperation with a PC to take place without requiring transmission of a forward position to the PC.

### BRIEF DESCRIPTION OF DRAWINGS

FIG. 1 is a schematic hardware configuration diagram of a control device and an interference check device according to one embodiment of the present invention.

FIG. 2 is a schematic block diagram illustrating functions of the control device and the interference check device according to one embodiment of the present invention.

FIG. 3 is a diagram illustrating an example of a motion part and an obstacle.

FIG. 4 is a diagram illustrating an example in which the motion part is moved in a Y-axis direction.

FIG. 5 is a diagram illustrating an example in which the motion part is moved in an X-axis direction.

FIG. 6 is a diagram illustrating an example in which the motion part is moved in a B-axis direction.

FIG. 7 is a sequence chart illustrating a flow of interference check according to one embodiment of the present invention.

FIG. 8A is a diagram illustrating an example of the relationship between an actual position and a current position of the motion part when current position is calculated.

FIG. 8B is a diagram illustrating an example of the relationship between an actual position, a current position, and a check position of the motion part when prohibited motion amount is calculated.

FIG. 8C is a diagram illustrating an example of the relationship between an actual position, a current position, a check position, and an interference position of the motion part when interference is determined.

FIG. 8D is a diagram illustrating an example of the relationship between an actual position, a current position, a check position, and an interference position of the motion part when motion part is stopped.

FIG. 9 is a block diagram illustrating a modified example for the control device and the interference check device according to one embodiment of the present invention.

FIG. 10 is a diagram illustrating interference between a motion part and an obstacle.

FIG. 11 is a sequence chart illustrating a flow of PC-cooperative type interference check.

### DESCRIPTION OF EMBODIMENTS

An embodiment of the present invention will be described below with reference to the drawings.

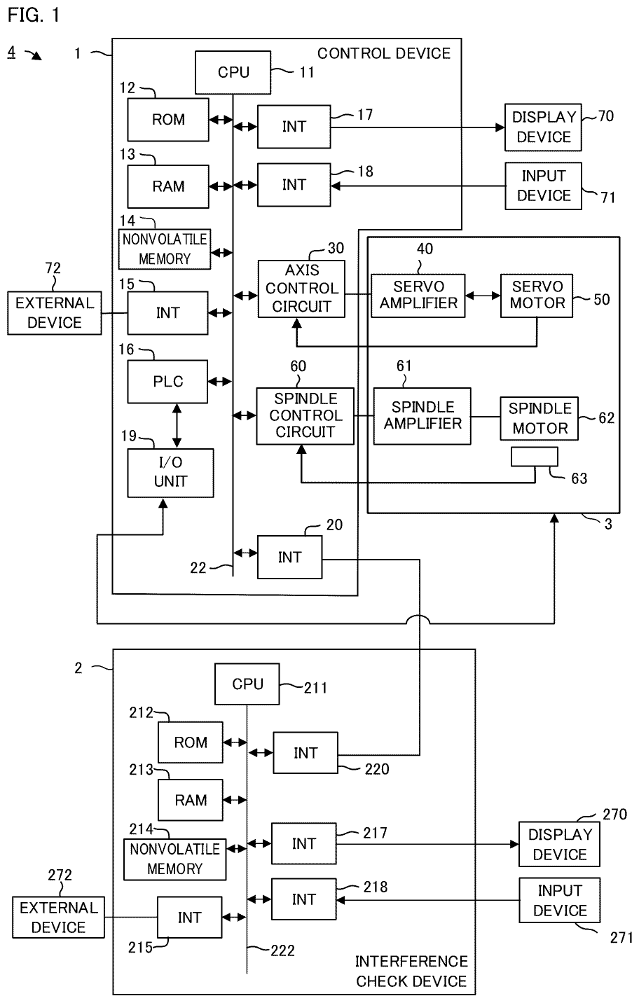

FIG. 1 is a schematic hardware configuration diagram illustrating a main part of a control device according to one embodiment of the present invention. A control device 1 of the present invention forms a control system 4 together with an interference check device 2 constructed on a personal computer attached to the control device 1. The control device 1 controls the industrial machine 3 such as a machine tool or a machining center, for example.

A CPU 11 of the control device 1 according to the present embodiment is a processor that entirely controls the control device 1. The CPU 11 reads a system program stored in a ROM 12 via a bus 22 and controls the overall control device 1 in accordance with the system program. A RAM 13 temporarily stores temporary calculation data or display data, various data input from outside, and the like.

A nonvolatile memory 14 is formed of a memory, a solid state drive (SSD), or the like backed up by a battery (not illustrated), for example, and the storage state is held even when the control device 1 is powered off. The nonvolatile memory 14 stores a control program or data loaded from an external device 72 via an interface 15, a control program or data input from an input device 71 via an interface 18, a control program or data acquired from other devices such as a fog computer 6 or a cloud server 7 via a network 5, or the like. The data stored in the nonvolatile memory 14 may include, for example, data on a machine configuration of the industrial machine 3, data on an obstacle such as a workpiece or a jig, data on motion of a motion part along each axis, other data on respective physical amounts detected by sensors (not illustrated) mounted on the industrial machine 3, or the like. The control program or data stored in the nonvolatile memory 14 may be loaded into the RAM 13 during execution/during use. Further, various system programs such as a known analysis program are written in the ROM 12 in advance.

The interface 15 is an interface for connecting the CPU 11 of the control device 1 and the external device 72 such as an external storage medium to each other. From the external device 72 side, for example, a control program, setup data, or the like used for control of the industrial machine 3 are loaded. Further, a control program, setup data, or the like edited in the control device 1 can be stored in an external storage medium such as a CF card, a USB memory, or the like (not illustrated) via the external device 72. A programmable logic controller (PLC) 16 executes a ladder program to input and output signals to and control the industrial machine 3 and peripheral devices (for example, a tool exchanger, an actuator such as a robot, a sensor mounted on the industrial machine 3, or the like) of the industrial machine 3 via an I/O unit 19. Further, the PLC 16 receives signals from various switches on an operation panel, a peripheral device, or the like deployed to the body of the industrial machine 3, performs required signal processing on the signals, and then passes the signals to the CPU 11.

An interface 20 is an interface for connecting a CPU of the control device 1 and the interference check device 2 via a wired or wireless connection. The connection between the control device 1 and the interference check device 2 may be a connection for communication using a technology such as serial communication such as RS-485, Ethernet (registered trademark) communication, optical communication, a wireless LAN, Wi-Fi (registered trademark), Bluetooth (registered trademark), or the like, for example. The control device 1 transfers data interactively with the interference check device 2 via the interface 20.

Various data loaded onto the memory, data obtained as a result of execution of a program or the like, or the like are output and displayed on a display device 70 via an interface 17. Further, the input device 71 formed of a keyboard, a pointing device, or the like passes a command, data, or the like based on an operation performed by an operator to the CPU 11 via the interface 18.

An axis control circuit 30 for moving a motion part of the industrial machine 3 receives motion command amounts from the CPU 11 and outputs motion commands to servo amplifiers 40, respectively. The servo amplifiers 40 receive these commands and drive servo motors 50 of the industrial machine 3, respectively. Each servo motor 50 has a built-in position and velocity detector and feeds a position and velocity feedback signal from the position and velocity detector back to the axis control circuit 30 to perform feedback control of the position and velocity. Note that, although only one axis control circuit 30, one servo amplifier 40, and one servo motor 50 are illustrated in the hardware configuration diagram of FIG. 1, these components may be provided for the same number as that of motion parts of the industrial machine 3 to be controlled in the actual implementation.

A spindle control circuit 60 receives a spindle rotation command and outputs a spindle speed signal to a spindle amplifier 61. The spindle amplifier 61 receives the spindle speed signal and rotates a spindle motor 62 of the industrial machine at the instructed rotational rate to drive a tool. A position coder 63 is coupled to the spindle motor 62, the position coder 63 outputs feedback pulses in synchronization with rotation of the spindle, and the feedback pulses are read by the CPU 11.

On the other hand, the interference check device 2 according to the present embodiment is constructed on a PC attached to the control device 1. A CPU 211 of the interference check device 2 is a processor that entirely controls the interference check device 2. The CPU 211 reads a system program stored in a ROM 212 via a bus 222 and controls the overall interference check device 2 in accordance with the system program. A RAM 213 temporarily stores temporary calculation data or display data, various data input from outside, and the like.

A nonvolatile memory 214 is formed of a memory, a solid state drive (SSD), or the like backed up by a battery (not illustrated), for example, and the storage state is held even when the interference check device 2 is powered off. The nonvolatile memory 214 stores data acquired from the control device 1 via an interface 220, data or a program loaded from an external device 272 via an interface 215, data or a program input via an input device 271, or the like. The data or the program stored in the nonvolatile memory 214 may be loaded into the RAM 213 during execution/during use. Further, various system programs such as a known processing program or analysis program, 3D simulation program, or the like are written in the ROM 212 in advance.

The interface 215 is an interface for connecting the CPU 211 of the interference check device 2 and the external device 272 such as an USB device to each other. From the external device 272 side, for example, a program, respective parameters, or the like used for analysis can be loaded. Further, a program, respective parameters, or the like edited in the interference check device 2 can be stored in an external storage unit via the external device 272.

The interface 220 is an interface for connecting the CPU 211 of the interference check device 2 and the control device 1 via a wired or wireless connection. The interference check device 2 transfers data interactively with the control device 1 via the interface 220.

Various data loaded onto the memory, data obtained as a result of execution of a machining program, a system program, or the like, or the like are output and displayed on a display device 270 via an interface 217. Further, the input device 271 formed of a keyboard, a pointing device, or the like passes a command, data, or the like based on an operation performed by an operator to the CPU 211 via the interface 218.

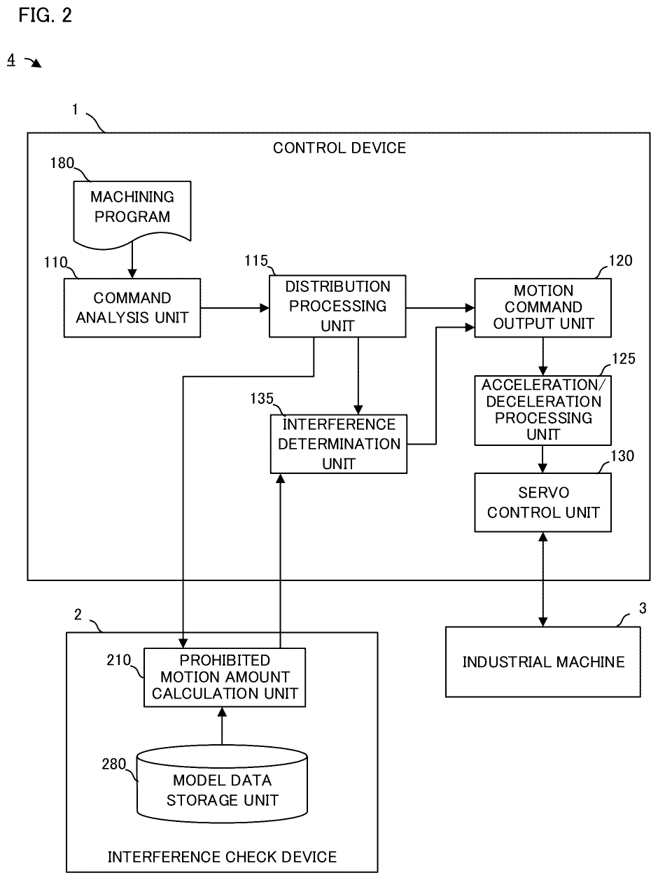

FIG. 2 illustrates the functions of the control device 1 according to a first embodiment of the present invention as a schematic block diagram. Respective functions of the control device 1 according to the present embodiment are implemented when the CPU 11 of the control device 1 illustrated in FIG. 1 executes the system program to control the operations of respective units of the control device 1.

The control device 1 of the present embodiment includes a command analysis unit 110, a distribution processing unit 115, a motion command output unit 120, an acceleration/deceleration processing unit 125, a servo control unit 130, and an interference determination unit 135. Further, the interference check device 2 includes a prohibited motion amount calculation unit 210. Furthermore, the RAM 13 or the nonvolatile memory 14 of the control device 1 stores in advance a machining program 180 used for control of the industrial machine 3.

The command analysis unit 110 reads a command on a block basis from the machining program 180 and analyzes the command to create data in an execution format. The command analysis unit 110 outputs the data in the execution format to the distribution processing unit 115.

The distribution processing unit 115 calculates a distributed motion amount for each distribution cycle for motion on each axis at instructed motion amount and speed based on data in the execution format input from the command analysis unit 110. The distribution processing unit 115 outputs the calculated distributed motion amounts to the motion command output unit 120 and the prohibited motion amount calculation unit 210 of the interference check device 2.

Further, the distribution processing unit 115 updates information on the current position on each axis of the industrial machine 3 stored in a current position register (not illustrated) by adding a calculated distributed motion amount thereto. Then, the updated information on the current position is output as a check position to the interference determination unit 135 and the prohibited motion amount calculation unit 210 of the interference check device 2.

The motion command output unit 120 outputs the distributed motion amount calculated by the distribution processing unit 115 to the acceleration/deceleration processing unit 125. Further, when the interference determination unit 135 determines that interference is expected to occur, the motion command output unit 120 stops output of the distributed motion amount to the acceleration/deceleration processing unit 125.

The acceleration/deceleration processing unit 125 performs a predetermined acceleration/deceleration process on a distributed motion amount input from the motion command output unit 120. Then, the distributed motion amount subjected to the acceleration/deceleration process is output to the servo control unit 130.

Then, the servo control unit 130 drives and controls the servo motor 50 mounted on the industrial machine 3 based on the input distributed motion amount.

The interference determination unit 135 determines whether or not interference is expected in the motion of the motion part of the industrial machine 3 based on the check position input forward from the distribution processing unit 115 and the prohibited motion amount on each axis input from the interference check device 2. More specifically, the interference determination unit 135 compares a distributed motion amount on each axis from the check position input from the distribution processing unit 115 (a distributed motion amount calculated by the distribution processing unit 115) with the prohibited motion amount on each axis from the check position input from the interference check device 2. Then, when the distributed motion amount is greater than or equal to the prohibited motion amount, it is determined that interference is expected to occur. When it is determined that interference is expected to occur, the interference determination unit 135 outputs the determination to the motion command output unit 120.

On the other hand, each function of the interference check device 2 according to the present embodiment is implemented when the CPU 211 of the interference check device 2 illustrated in FIG. 1 executes the system program to control the operation of each unit of the interference check device 2. The interference check device 2 of the present embodiment includes a prohibited motion amount calculation unit 210. Further, in the RAM 213 or the nonvolatile memory 214 of the interference check device 2, a model data storage unit 280 storing models indicating the shapes of the motion part of the industrial machine 3 and obstacles such as a workpiece, a table, a jig, or the like in advance is prepared.

The prohibited motion amount calculation unit 210 performs a simple simulation process based on the models of a motion part and obstacles stored in the model data storage unit 280. Then, the prohibited motion amount calculation unit 210 calculates a prohibited motion amount indicating what distance the motion part can move before the motion part is likely to interfere with the obstacle when the motion part moves along each axis from the check position. The prohibited motion amount calculation unit 210 transmits the calculated prohibited motion amount on each axis to the control device 1.

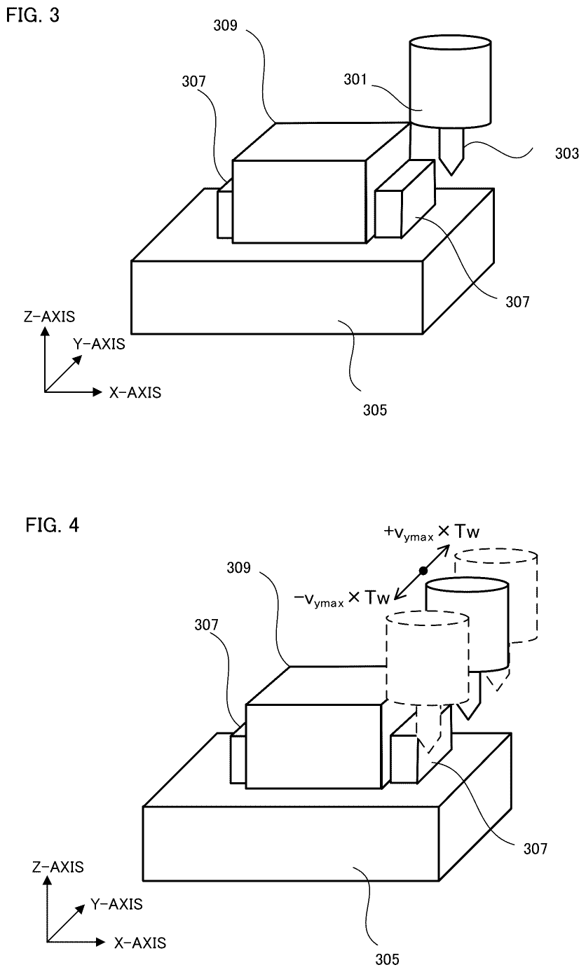

A method of calculating a prohibited motion amount performed by the prohibited motion amount calculation unit 210 will be described with reference to FIG. 3 to FIG. 6. FIG. 3 is a diagram in which a spindle 301 to which a tool 303 as a motion part is attached, a table 305, a workpiece 309, and a jig 307 that fixes the workpiece 309 as obstacles are arranged. The prohibited motion amount calculation unit 210 performs a simulation process to calculate the positional relationship between the motion part located at the check position and the obstacles. FIG. 3 illustrates a case where the motion: is located at the current position output from the distribution processing unit 115 to the prohibited motion amount calculation unit 210.

Next, the prohibited motion amount calculation unit 210 calculates a distance by which the motion part may be moved from the check position during a predetermined check time width T_{W} defined in advance for each axis. For example, it is assumed that the motion part is pre-set to be movable at a tolerated velocity v_{ymax} in the Y-axis direction. In such a case, the motion part may move by a distance of v_{ymax}×T_{W} during the check time width T_{W} in the Y-axis direction. Accordingly, as illustrated in FIG. 4 as an example, the prohibited motion amount calculation unit 210 simulates whether or not interference with an obstacle occurs when the motion part moves to a position that is distant from the check position by a distance of ±v_{ymax}×T_{W} along the Y-axis. More specifically, for example, the motion part is moved in predetermined increments Δd_{y} defined in advance within a range of the distance of v_{ymax}×T_{W}, and a simulation is performed at respective positions. It is then determined whether or not interference occurs in respective cases to find a range of the distance where no interference is expected to occur. Such a distance where no interference is expected to occur can be calculated as the prohibited motion amount. In the example of FIG. 4, since no interference occurs between the motion part and the obstacle even when the motion part is moved by a distance of ±v_{ymax}×T_{W} along the Y-axis, the prohibited motion amount in the Y-axis direction is not calculated (there is no limitation in both the positive and negative directions on the Y-axis).

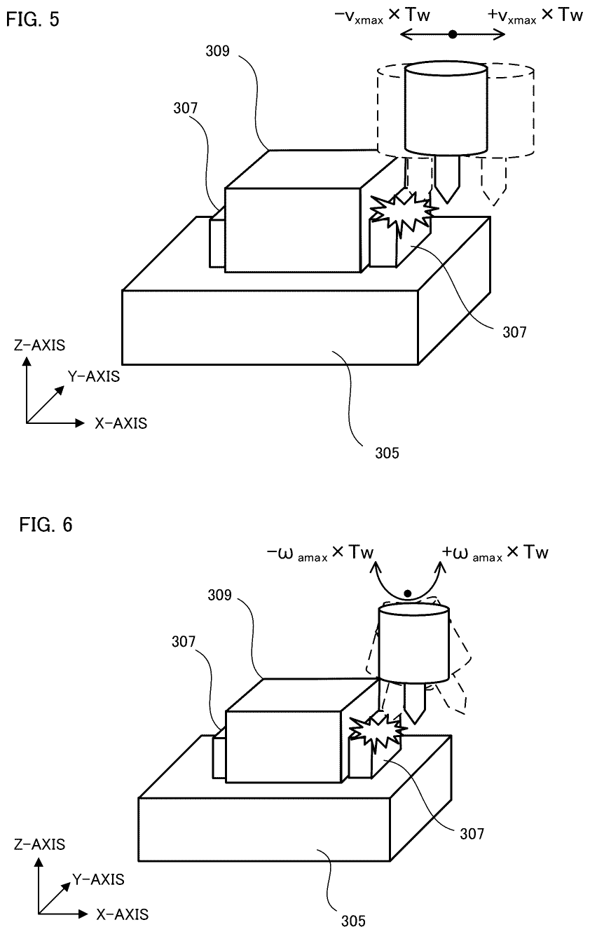

In contrast, when the motion part is movable at a tolerated velocity vₓₘₐₓ in the X-axis direction, the motion part may move by a distance of vₓₘₐₓ×T_{W} during the check time width T_{W} in the X-axis direction. Accordingly, as illustrated in FIG. 5 as an example, the prohibited motion amount calculation unit 210 simulates whether or not interference with an obstacle occurs when the motion part moves to a position that is distant from the check position by a distance of ±vₓₘₐₓ×T_{W} along the X-axis. In the example of FIG. 5, when the motion part is moved by a distance of ±vₓₘₐₓ×T_{W} along the X-axis, interference will occur at a point of time that the motion part has moved by −d_{xcol} in the negative direction on the X-axis. In such a case, the prohibited motion amount calculation unit 210 calculates the prohibited motion amount in the X-axis negative direction to be d_{xcol} (there is no limitation in the X-axis positive direction).

The prohibited motion amount calculation unit 210 can calculates a prohibited motion amount not only for a linear axis but also for a rotational axis. For example, as illustrated in FIG. 6 as an example, a case where a prohibited motion amount on a B-axis is calculated in the industrial machine 3 having the B-axis is considered. In this example, when the B-axis is rotatable at a tolerated angular velocity ωₐₘₐₓ, the motion part may rotate by an angle of ωₐₘₐₓ×T_{W} during the check time width T_{W} in the B-axis direction. As illustrated in FIG. 6 as an example, the prohibited motion amount calculation unit 210 simulates whether or not interference with an obstacle occurs when the motion part rotates by an angle of ±ωₐₘₐₓ×T_{W} along the B-axis from the check position. In the example of FIG. 6, when the motion part is rotated by an angle of ±ωₐₘₐₓ×T_{W} along the B-axis, interference will occur at a point of time that the motion part has rotated by −d_{acol} in the negative direction on the B-axis. In such a case, the prohibited motion amount calculation unit 210 calculates the prohibited motion amount in the B-axis negative direction to be d_{acol} (there is no limitation in the B-axis positive direction).

Note that, in the method of calculating a prohibited motion amount described above, a range of combined motion on respective axes of the industrial machine 3 is not considered. Thus, it is not possible to check interference in a strict sense. However, it is possible to perform interference check k at sufficient accuracy by setting a smaller T_{W} that is set as a time range of interference check. For example, by limiting T_{W} to several hundred milliseconds or less, it is possible to perform interference check at such accuracy that can avoid interference that may occur in machining with a typical machine tool. In this method, a calculation amount required for interference check is significantly reduced compared to a case where the range of combined motion on respective axes is taken into consideration to perform interference check. Thus, when the method of calculating the prohibited motion amount described above is employed, the PC used for the interference check device 2 can be relatively inexpensive, and introduction costs can be suppressed as a whole.

Naturally, when the industrial machine 3 having a small number of axes is a target, since the calculation amount in the interference check device 2 is sufficiently small, and strict interference check taking combined motion amount on respective axes into consideration may be performed. Further, by constructing the interference check device 2 on a high-performance PC, the high-performance PC can be caused to calculate a stricter prohibited motion amount taking a combined motion amount on respective axes into consideration even with a large number of axes and can be used as a part of the present invention. In a case of such a configuration, the prohibited motion amount on each axis may be created in a form of a function whose value changes in accordance with ranges of motion amounts of the remaining axes and may be output to the control device 1.

It is desirable for the prohibited motion amount calculation unit 210 to calculate a value that is smaller by a predetermined margin amount defined in advance as a prohibited motion amount for a safety measure. For example, in the example described above, the prohibited motion amount calculation unit 210 can calculate a prohibited motion amount in the X-axis negative direction to be d_{xcol}−Mₓ(Mₓ is a margin amount on the X-axis), a prohibited motion amount in the B-axis negative direction to be d_{acol}−Mₐ (Mₐ is a margin amount on the B-axis), or the like.

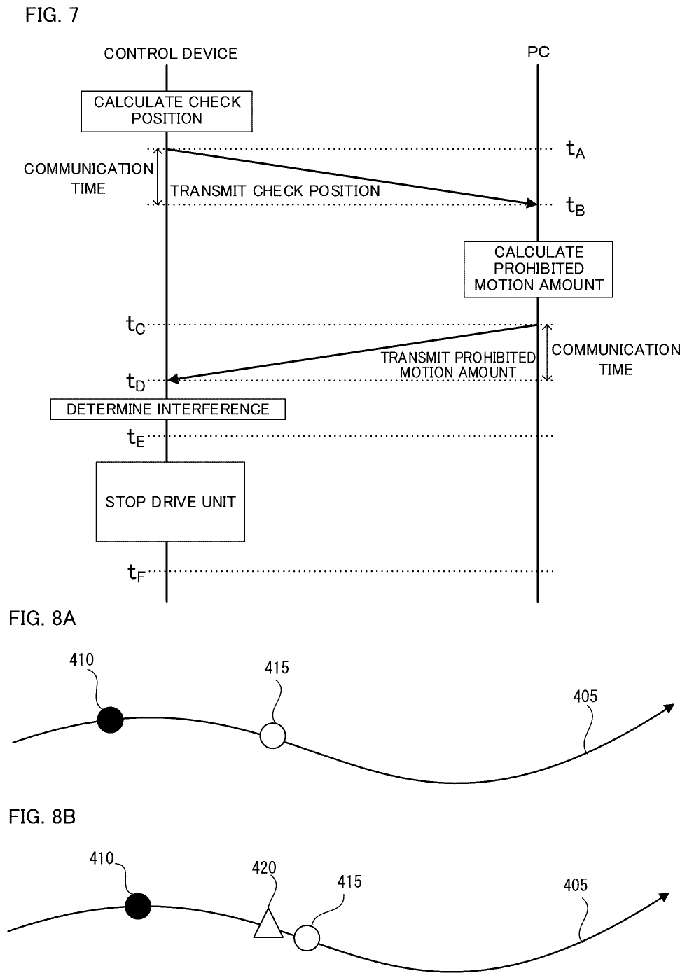

FIG. 7 is a sequence chart illustrating a flow of the interference check process in the control system 4 in which the control device 1 and the interference check device 2 cooperate with each other as described above. When the control device 1 and the interference check device 2 cooperate with each other to perform interference check, the control device 1 calculates a coordinate value of a position at which interference check will take place and transmits the calculated coordinate value to the interference check device 2 at time t_{A}. The interference check device 2 that received the coordinate value of the check position at time t_{B} uses models of the motion part and the obstacle stored in advance to check whether or not interference is expected to occur within a range where the motion part may move along each axis from the transmitted coordinate value of the check position during a predetermined check time width T_{W}. Then, a prohibited motion amount on each axis is calculated based on the check result. The calculated prohibited motion amount for each axis is transmitted to the control device at time t_{C}. The control device 1 that received the prohibited motion amount for each axis at time to compares a currently output distributed motion amount for each axis with the prohibited motion amount and determines whether or not interference is expected to occur. Then, when it is determined that interference is expected to occur, a process to stop the motion part is started at time t_{E}. Then, the motion part is stopped at time t_{F}.

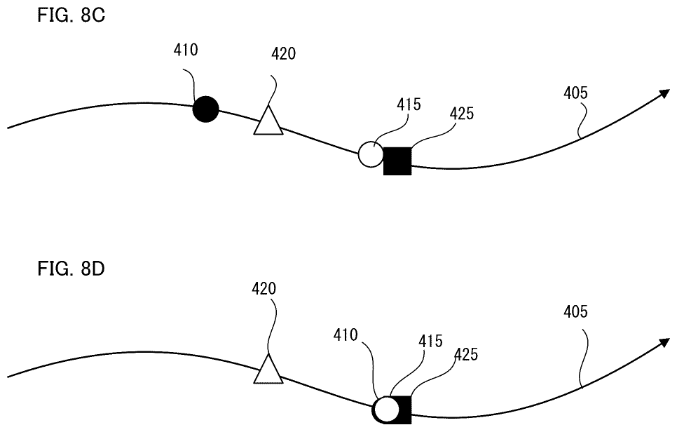

Next, the relationship between an actual position of the motion part in the industrial machine 3, a current position of the motion part set in a current position register of the control device 1, and a check position checked by the interference check device 2 at each point of time that interference check is performed will be described with reference to FIG. 8A to FIG. 8D. Note that, in FIG. 8A to FIG. 8D, each arrow represents a motion path 405 of the motion part instructed by the machining program 180. Further, each black circle represents an actual position 410 of the motion part, each white circle represents a current position 415 of the motion part set in the register, each white triangle represents a check position 420, and each black square represents an interference position 425.

FIG. 8A is a diagram illustrating the positional relationship between the actual position 410 and the current position 415 at time t_{A} illustrated in FIG. 7. As also described above, at time t_{A}, the current position of the motion part set in the current position register is updated based on the distributed motion amount. Then, the updated current position is output to the interference check device 2 as the check position. As illustrated in FIG. 8A as an example, the actual position 410 of the motion part of the industrial machine 3 is always delayed from the updated current position 415 in the control device 1 while the motion part is in motion.

FIG. 8B is a diagram illustrating the positional relationship between the actual position 410, the current position 415, and the check position 420 at time to. Before the current position output from the distribution processing unit 115 is input to the interference check device 2 as the check position, each process of analysis and distribution of the machining program 180 at the control device 1 and motion of the motion part at the industrial machine 3 are performed. Thus, as illustrated in FIG. 8B, the actual position 410 and the current position 415 move forward along the motion path 405 from the point of time t_{A}. On the other hand, the check position 420 is at the same position as the current position 415 at the point of time t_{A}. Then, the actual position 410 and the current position 415 move forward along the motion path 405 during calculation of a prohibited motion amount by the prohibited motion amount calculation unit 210.

FIG. 8C is a diagram illustrating the positional relationship between the actual position 410, the current position 415, the check position 420, and the interference position 425 at time to. Before a prohibited motion amount for each axis is calculated and output to the control device 1 by the prohibited motion amount calculation unit 210, the actual position 410 and the current position 415 further move forward along the motion path 405. Then, at a point of time (time t_{E}) that the interference determination unit 135 determines that interference is expected to occur, the actual position 410 of the motion part has to be located at a position of the check position plus the prohibited motion amount, that is, at a position backward of the interference position 425 by at least a distance related to stopping of the motion part. As long as the motion part is located backward by the distance related to stopping of the motion part or longer, the motion of the motion part stops before reaching the interference position 425 at the point of time t_{F}, as illustrated in FIG. 8D.

As can be understood from the above description, during a period in which the control device 1 transmits a check position to the interference check device 2, the interference check device 2 calculates a prohibited motion amount, and the control device 1 receives the calculated prohibited motion amount, the control device 1 analyzes the command of the machining program 180 and continues update of the current position, and the motion part of the industrial machine 3 continues to move. Thus, the interference determination unit 135 is required to make determination about interference by using the previous check position and the prohibited motion amount before the control device 1 receives a determination result at the check position output to the interference check device 2. For example, the check time width T_{W} can be set to satisfy Equation 1 below, where the check cycle in the interference check device 2 is T_{PC}, a time taken for check position notification is T₁=(t_{B}−t_{A}), a processing time taken for prohibited motion amount calculation is T_{C}=(t_{C}−t_{B}), a time taken for prohibited motion amount notification is T₂=(t_{D}−t_{C}), a processing time taken for interference determination is T₃=(t_{E}−t_{D}), and a time taken for slowdown and stop is T_{S}=(t_{F}−t_{E}). With such a setting, ranges of interference check in calculation of respective prohibited motion amounts partially overlap. Thus, while the interference check device 2 is being requested for calculation of a prohibited motion amount, a range of interference determination using the previous check position and the prohibited motion amount is sufficient.

$${T}_{W} > {T}_{P C} + {T}_{1} + {T}_{C} + {T}_{2} + {T}_{3} \qquad [ Math 1 ]$$

The control device 1 having the above configuration enables interference check in cooperation with the interference check device 2 (PC) to take place without requiring transmission of a forward position to the interference check device 2. Since it is no longer required to manage two position coordinates of the current position and the forward position in the control device 1, it is possible to manage a motion position of a motion part through simple processing. Further, since the control device 1 can perform interference check by using currently recognized positions, it is also possible to address a case where a predicted candidate of a forward position is divided into two or more in accordance with a situation. Similarly, the control device 1 is applicable to a case where a forward position is unable to be predicted such as in a case of manual operation.

Although the embodiment of the present invention has been described above, the present invention is not limited to only the examples of the embodiment described above and can be implemented in various forms with addition of a suitable change.

For example, the distribution processing unit 115 of the control device 1 may be configured to transmit information that is useful to identify a range where the motion part can move within the check time width T_{W} to the interference check device together with the check position when transmitting the check position. Examples of the information that is useful to identify a range where the motion part can move within the check time width T_{W} may be information on a tolerated velocity, a tolerated acceleration, a tolerated jerk, the current velocity, whether or not there is motion about an axis, or the like. The prohibited motion amount calculation unit 210 can more strictly calculate a range where the motion part can move within the check time width T_{W} by using the above information. For example, since a velocity that can be reached within the check time width T_{W} can be calculated from a current velocity and a tolerated acceleration, it is possible to limit the motion range of the motion part with the calculated velocity being as the maximum velocity. Further, when there is no motion about a certain axis, calculation related to this axis can be omitted. Such information contributes to a reduction in the calculation cost in the interference check device 2.

Further, in the embodiment described above, the interference determination unit 135 compares a prohibited motion amount with a distributed motion amount calculated by the distribution processing unit 115 and determines that interference is expected to occur when the distributed motion amount is greater than or equal to the prohibited motion amount. However, the interference determination unit 135 may compare a prohibited motion amount with a distributed motion amount resulted by the acceleration/deceleration processing unit 125 performing a predetermined acceleration/deceleration process.

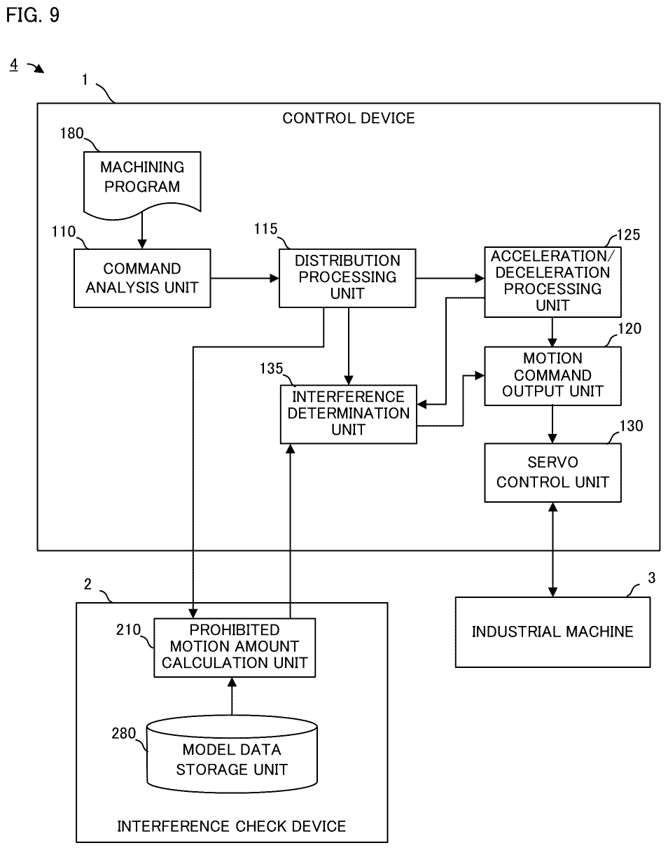

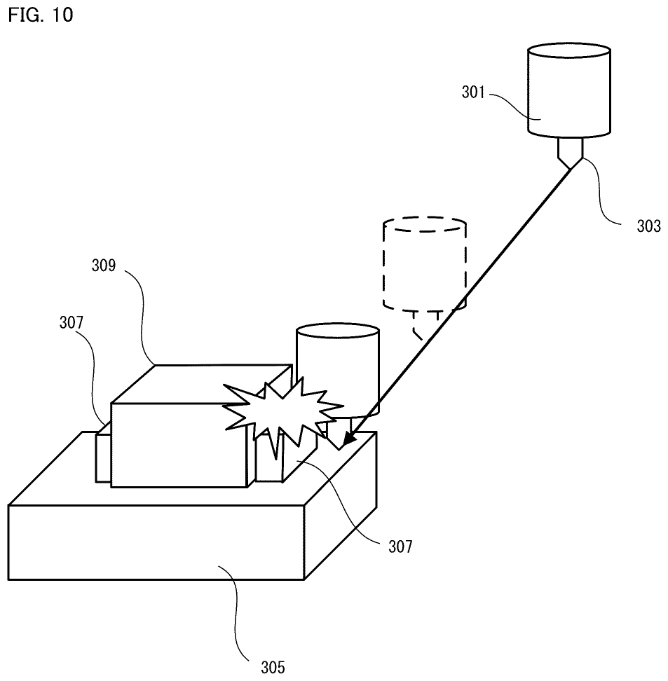

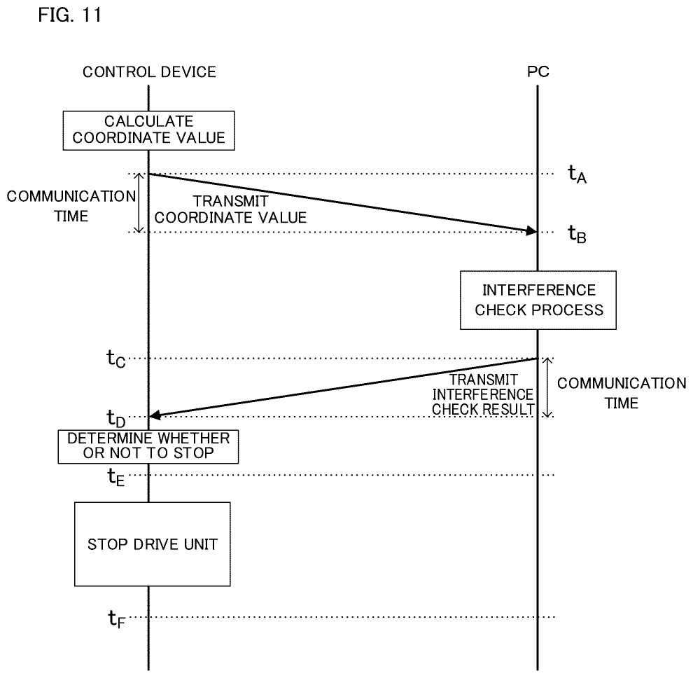

FIG. 9 illustrates functions of the control device 1 as a schematic block diagram when a position calculated based on a distributed motion amount resulted by the acceleration/deceleration processing unit 125 performing an acceleration/deceleration process is used as a check position. In the control device 1 according to the present modified example, the interference determination unit 135 compares a distributed motion amount forward from a check position input from the acceleration/deceleration processing unit 125 with a prohibited motion amount for each axis from a check position input from the interference check device 2. Then, if the distributed motion amount forward from the check position input from the acceleration/deceleration processing unit 125 is greater than or equal to the prohibited motion amount, it is determined that interference is expected to occur. When it is determined that interference is expected to occur, the interference determination unit 135 outputs the determination to the motion command output unit 120. Then, when the interference determination unit 135 determines that interference is expected to occur, the motion command output unit 120 stops the output of the motion command to the servo control unit 130.

The distributed motion amount resulted by the acceleration/deceleration processing unit 125 performing an acceleration/deceleration process is output to the servo control unit 130 as a motion command. This enables the control device 1 of this modified example to perform stricter interference check compared to a case where interference determination is made based on a distributed motion amount calculated by the distribution processing unit 115.

1. A control device that controls motion of a motion part of an industrial machine along an axis based on a machining program, wherein the control device performs interference check in cooperation with an interference check device that checks interference between the motion part and an obstacle, the control device comprising:
a command analysis unit that analyzes a block of the machining program;
a distribution processing unit that creates a distributed motion amount for each distribution cycle based on an analysis result from the command analysis unit, calculates a position of the motion part updated by the distributed motion amount, and notifies the interference check device of the calculated position; and
an interference determination unit determines whether or not interference between the motion part and the obstacle is expected based on a prohibited motion amount calculated by the interference check device based on the notified position, the prohibited motion amount being such a distance that is likely to cause interference when the motion part moves by the distance from the position of the motion part,
wherein when it is determined by the interference determination unit that interference between the motion part and the obstacle is expected to occur, motion of the motion part is stopped.

2. The control device according to claim 1 further comprising an acceleration/deceleration processing unit that performs a predetermined acceleration/deceleration process on a distributed motion amount for each distribution cycle created by the distribution processing unit,
wherein the interference determination unit determines whether or not interference between the motion part and the obstacle is expected by comparing the prohibited motion amount with a motion amount forward from the position calculated based on the distributed motion amount on which the predetermined acceleration/deceleration process was performed by the acceleration/deceleration processing unit.

3. The control device according to claim 1, wherein the distribution processing unit further notifies the interference check device of information that is useful to identify a range where the motion part is able to move in addition to the position of the motion part.

4. An interference check device that checks interference between a motion part moving along an axis of an industrial machine and an obstacle, the interference check device comprising:
a model data storage unit that stores models of the motion part and the obstacle; and
a prohibited motion amount calculation unit that, based on a position of the motion part notified from a control device that controls the industrial machine and on the models of the motion part and the obstacle stored in the model data storage unit, calculates a prohibited motion amount that is likely to cause interference when the motion part moves by the prohibited motion amount from the position of the motion part,
wherein the calculated prohibited motion amount is transmitted to the control device.

5. The interference check device according to claim 4, wherein a motion range of the motion part in the interference check is set so as to partially overlap a motion range of the motion part in interference check in a next cycle.

6. A control system in which a control device and an interference check device cooperate to perform interference check, wherein the control device controls motion of a motion part of an industrial machine along an axis based on a machining program, and the interference check device checks interference between the motion part and an obstacle,
wherein the interference check device comprises
a model data storage unit that stores models of the motion part and the obstacle, and
a prohibited motion amount calculation unit that, based on a position of the motion part notified from the control device and on the models of the motion part and the obstacle stored in the model data storage unit, calculates a prohibited motion amount that is likely to cause interference when the motion part moves by the prohibited motion amount from the position of the motion part, and
wherein the control device comprises
a command analysis unit that analyzes a block of the machining program,
a distribution processing unit that creates a distributed motion amount for each distribution cycle based on an analysis result from the command analysis unit, calculates a position of the motion part updated by the distributed motion amount, and notifies the interference check device of the calculated position, and
an interference determination unit that determines whether or not interference between the motion part and the obstacle is expected based on a prohibited motion amount calculated by the prohibited motion amount calculation unit, and
wherein when it is determined by the interference determination unit that interference between the motion part and the obstacle is expected to occur, motion of the motion part is stopped.
